(19) United States
(12) Patent Application Publication
(10) Pub. No.: US 2012/0166291 A1
(43) Pub. Date: Jun. 28, 2012

(54) BID GENERATION FOR SPONSORED SEARCH

(75) Inventors: Andrei Broder, Menlo Park, CA (US); Evgeniy Gabrilovich, Sunnyvale, CA (US); Vanja Josifovski, Los Gatos, CA (US); George Mavromatis, Mountain View, CA (US); Benjamin Rey, Versailles (FR)

(73) Assignee: Yahoo! Inc., SUNNYVALE, CA (US)

(21) Appl. No.: 12/977,313

(22) Filed: Dec. 23, 2010

(51) Int. Cl. G06Q 30/00

(52) U.S. Cl. 705/14.71

(57) ABSTRACT

A system and method of generating bid values for sponsored search includes steps or acts of: receiving a bid phrase for an advertisement for an item, wherein the bid phrase specifies a search query for which the advertisement should be displayed; receiving first information at a first input/output interface, the first information related to a bidding behavior of the advertiser; receiving second information at a second input/output interface, the second information relating to a history of bids by other advertisers for the bid phrase; and generating a bid value for the bid phrase submitted for the advertisement for the search query, based on the information received.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of sponsored search and more particularly relates to the field of bid generation for sponsored search.

### BACKGROUND OF THE INVENTION

Presenting advertisements alongside Web search results is known as “sponsored search.” Sponsored search is one of the key financial drivers of the Internet economy. It provides traffic to hundreds of thousands of Web sites, and accounts for a large portion of the $30 billion online advertising expenditures. Sponsored search is a three-way interaction between advertisers, users, and the search engine. Sponsored search places ads on the result pages of a Web search engine, where ads are selected to be relevant to the search query. All major Web search engines (Google, Microsoft, Yahoo!) support sponsored ads and act simultaneously as a Web search engine and an ad search engine. Content match (or contextual advertising) places ads on third-party Web pages. Today, almost all of the for-profit non-transactional Web sites rely at least to some extent on contextual advertising revenue. Content match supports sites that range from individual bloggers and small niche communities to large publishers such as major newspapers.

Historically, the ad selection process in sponsored search was delegated to the advertiser. For each ad, the advertiser specifies the queries for which the ad is to be shown, by explicitly listing them as bid phrases. Bid phrases represent those Web search queries that are expected to trigger the ad. Most often, ads are shown for queries that are expressly listed among the bid phrases for the ad, thus resulting in an exact match (i.e., identity) between the query and the bid phrase. An exact match occurs when a user enters a search term (query) that is exactly the same as the term for which the advertiser has proffered a bid. For example, Yahoo! Search Marketing will display your ad when a user searches for something online and you have already bid on the same keyword phrase. Yahoo! Search Marketing provides for singular/plural variations and common misspellings.

For example, an advertisement for the keyword “plasma television” will prompt a display ad for the following search queries:

plasma television (same)

plasma televisions (singular/plural variations)

plasma televisions (common misspellings)

However, this mechanism is limited. It is impossible for the advertisers to explicitly enumerate all of the queries for which their ad is relevant. Therefore, search engines also have the ability to analyze queries and modify them slightly in an attempt to match pre-defined bid phrases. This approach, called broad (or advanced) match, facilitates more flexible ad matching. As an example, consider an advertiser selling dog collars. This advertiser bids on queries such as ‘dog collar,’ ‘red dog collar,’ or ‘dog collars for poodles.’ However, it is unlikely that the advertiser will be able to list all possible shades and textures that a dog collar might exhibit, or all possible breeds of dogs for which such collars might be suitable, let alone more loosely related queries (e.g., dog harness, dog training). Again using the example of Yahoo! Search Marketing, an advanced match is a match that uses an advertiser's keywords in various contexts, such as in a phrase, separated by other words, or in a different order. It extends the search reach by displaying an ad for a broader range of search related to keywords, titles, descriptions, and/or web content. For example, using the “plasma television” bid phrase from the earlier example, an advanced match will display an ad for the following search queries:

plasma television (same)

plasma televisions (singular/plural variations)

plasma televisions (common misspellings)

buy a plasma television (in a phrase)

plasma or flat panel television (separated by word(s))

television with plasma screen (in a different order)

flat panel screen (sub-phrase query)

plasma (general/broad query)

42-inch plasma television (specific query term)

‘Brand A’ plasma television (specific query term)

In the advanced match scenario, the search engine is effectively bidding on behalf of the advertisers. However, there is no reported work that describes how to infer the appropriate bid value. Unlike exact match, there is no stated amount the advertisers should be charged. The difficulty lies in determining what bid should be used on the advertiser's behalf, given the absence of an exact bid-query pairing. Simply using the bids that advertisers choose for exact match may lead to over-charging the advertisers, as the relevance (and conversion) of queries chosen through advanced match might be inferior to those in exact match.

Matching ads to queries becomes more challenging in advanced match, as it can no longer be solved by simple record lookup. However, one major point remains unresolved—if the advertiser no longer explicitly bids on every query, how will the search engine automatically generate appropriate bids?

### SUMMARY OF THE INVENTION

Briefly, according to an embodiment of the invention a method of generating bid values for sponsored search includes steps or acts of: receiving a bid phrase for an advertisement for an item, wherein the bid phrase specifies a search query for which the advertisement should be displayed; receiving first information at a first input/output interface, the first information related to a bidding behavior of the advertiser; receiving second information at a second input/output interface, the second information relating to a history of bids by other advertisers for the bid phrase; and generating a bid value for the bid phrase submitted for the advertisement for the search query, based on the information received.

According to another embodiment of the present invention, a computer system is configured for performing the method steps above.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a high level block diagram showing an information processing system configured according to another embodiment of the invention;

FIG. 2 is a high-level flowchart of a method according to an embodiment of the invention;

FIG. 3 is a flow chart of the bid generation process according to an embodiment of the present invention;

FIG. 4 shows a general view of the advertiser utility funnel;

FIG. 5 shows a schema of an ad database for a given advertiser, according to an embodiment of the present invention;

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

Bid generation is a complex problem as it essentially seeks to match human reasoning and sales information about the business value of the bid phrases. We believe that merely using the bids of other phrases is insufficient. Instead, it is essential to take features of queries, advertisers and their combination into account. To this end, we define several feature families, which are used in a machine learning approach. In what follows, all textual features can be computed using stop word removal and stemming.

According to an embodiment of the present invention, we predict the bid of a given ad for a given query. To do this, we formulate three main kinds of features: 1) features characterizing the query; 2) features describing the ad (and the advertiser); and 3) features characterizing their interaction (i.e., the query-ad pair). We learn the appropriate bid amounts (through sampling), and this more accurate charging leads to higher ROI for advertisers. The bid value is crucial as it affects both the ad placement in revenue reordering, as well as how much the advertisers are charged in case of an ad click.

We now discuss a machine learning approach to solve the bid generation problem. This approach employs multiple information sources such as the general bid landscape, the bidding behavior of advertisers, as well as conversion data, to determine an appropriate bid for new queries. Conversion data reflects the fraction of users who actually purchase the product or service being advertised after clicking on the ad. Intuitively, this information is highly valuable for bid generation, since knowing how different bid phrases “convert” can lead to a better estimation of their true value to the advertiser. The conversion data lets us learn bid values which make sense given the conversion rate for similar queries and ads. We discuss the steps involved in integrating these sources of information, along with measures for rendering the system robust against potential attacks.

The method of bid generation according to an embodiment of the present invention can be advantageously used in generating entire ad campaigns given a feed of product descriptions; one would need to auto-generate all parts of the ad, including its title/creative, bid phrases, as well as bid amounts. The bid amounts can be generated using the disclosed method.

The bid landscape itself offers a useful glimpse into the thought process and economics of advertisers. Advertisers derive value from showing ads in a number of ways, be it the mere fact that the advertiser's brand name is promoted, that a user clicks on it, or that a user takes further (purchase) action based on the ad. While there are cases in which the current auction mechanism used by sponsored search (Generalized Second Price or GSP) is not truthful; in most of the cases it is in the advertiser's best interest to adjust his bid according to the value he associates with the ad. Accordingly, our approach does not assume that the market is strictly incentive compatible (this would require a mechanism other than the GSP auction); instead, we assume that the bids are generally correlated with the value an advertiser obtains.

For instance, the fact that an advertiser bids $1 on ‘dog collars’ but bids only $0.50 on ‘red dog collars’ suggests that the search engine should be bidding a similar or even lower price than $0.50 on ‘mauve dog collars.’ Obviously, if they needed to make the bidding decision explicitly, different advertisers might bid in substantially different ways, since some merchants might not even stock certain colors of dog collars, but we conjecture that the bidding data is sufficiently predictable in general.

The main contributions of this invention are threefold. First, we postulate the problem of bid generation for advanced match in sponsored search. While previous work has addressed the issue of ad relevance, to the best of our knowledge this is the first invention to address the issue of generating a bid for advanced match. This mechanism is an important aspect of advanced match, which becomes crucial when the auctioneer (in this case, the search engine) is effectively bidding on behalf of a participant in the auction.

Second, we propose using machine learning methods for bid generation, and formulate a regression problem by learning to predict new bids from observing existing bids in a large, real-life corpus of ads. Finally, our experiments using real advertising data from a major search engine show that the proposed method can very accurately predict the bids of actual advertisements.

In this discussion we focus on sponsored search, which is an interplay of the following three entities: 1) the advertiser provides the supply of ads. Usually the activity of the advertisers is organized around campaigns, which are defined by a set of ads with a particular temporal and thematic goal (e.g., sale of home appliances during the holiday season). As in traditional advertising, the goal of the advertisers can be broadly defined as promotion of products or services. 2) the search engine provides “real estate” for placing ads (i.e., allocates space on search results pages), and selects ads that are relevant to the user's query. 3) users issue the queries and examine the search results page (“SRP”) composed in most cases of web search results and sponsored search ads.

The prevalent pricing model for textual ads is that the advertisers pay for every click on the advertisement (pay-per-click or PPC). The amount paid by the advertiser for each sponsored search click is usually determined by an online auction process. The advertisers place bids on a search phrase, and their position in the column of ads displayed on the SRP is determined by their bid. Thus, each ad is annotated with one or more bid phrases. In addition to the bid phrase, an ad also contains a title usually displayed in bold font, and a creative, which is the few lines of text shown to the user. Each ad contains a URL (uniform resource locator) to the advertised Web page, called the landing page.

In the model currently used by all the major search engines, bid phrases serve a dual purpose: they explicitly specify queries for which the ad should be displayed, and simultaneously define the marketplace for the auction that determines the price of ad clicks. Obviously, the price depends on how much the advertisers are willing to bid for a click associated with a given query. For example, a contractor advertising his services on the Internet might be willing to pay a small amount of money when his ads are clicked from general queries such as “home remodeling,” but higher amounts if the ads are clicked from more focused queries such as “hardwood floors” or “laminate flooring.”

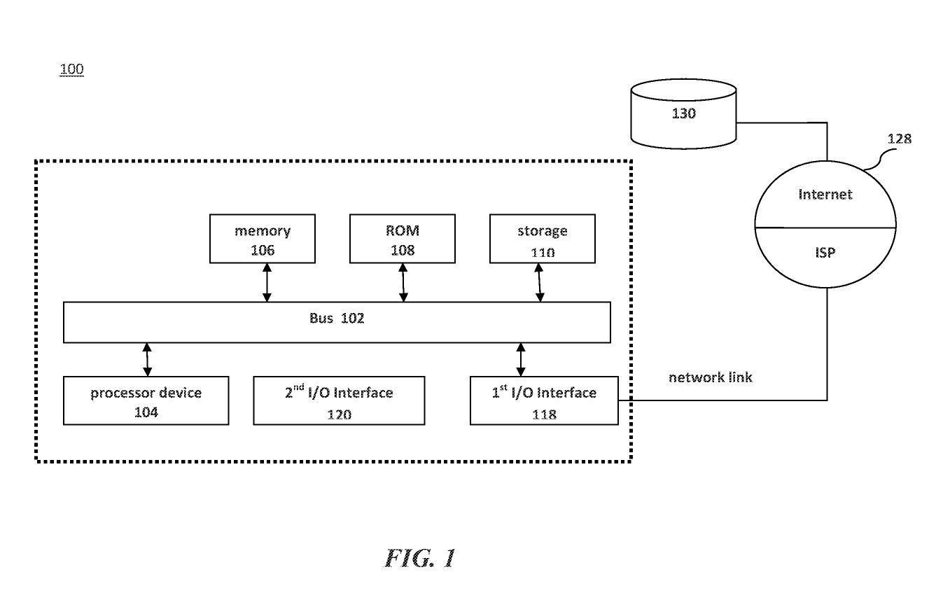

Referring to FIG. 1, there is shown a simplified block diagram of a system 100 for providing bids for advanced match in a search engine using sponsored search. The system 100 includes inter alia at least one processor device 104, memory 106, a storage device 110, and a first input/output interface 118. A second input/output interface 120 may also be included.

The memory 106 stores data and instructions that when executed by the processor device 104 cause the system to perform a bid generation method according to the invention. Read only memory (ROM) 108 is operatively coupled with the memory 106 and processor device 104 via a system bus 102. A communication interface 118 is operatively coupled with the other components also via the bus 102. The communication interface 118 enables connectivity to the Internet 128. A database 130 contains data regarding ads, advertisers, bids, and search queries.

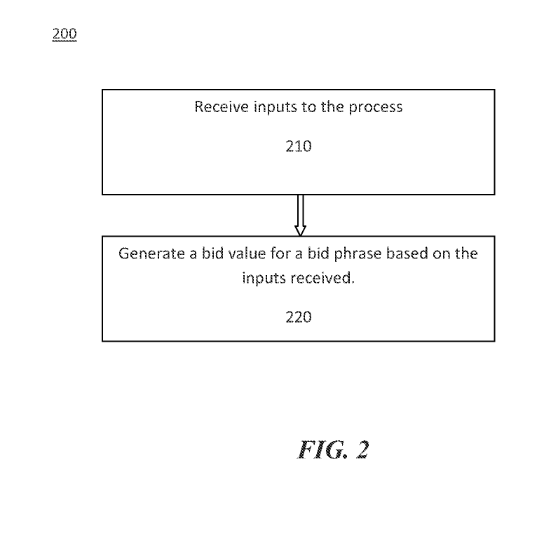

Referring to FIG. 2 we show a high-level flowchart 200 of a bid generation method, according to an embodiment of the present invention. First in step 210 we receive the inputs to the process. The inputs are the bid phrase intended to generate an ad; information related to a bidding behavior of the advertiser; and information related to history of bids by other advertisers for the bid phrase. In step 220 we generate a bid value for the bid phrase based on the information received.

Search Engine Perspective.

Receiving a query q a search engine may estimate the revenue R(q) from a click as follows: R^{k}=Pr(click|q, aₜ)·price(aₜ₂ i), i=1 where k is the number of ads displayed on the page with search results for q and price(aᵢ, i) is the click price of the ad at position i. The price in this model depends on the set of ads presented on the SRP. Several models have been proposed to determine this price; most of them based on generalizations and variants of second price (GSP) auctions.

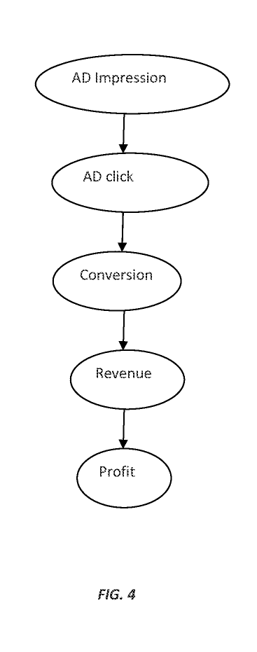

While textual ads appear as individual units to the user, in practice, the ads are hierarchically defined in a nested structure of several entities, as shown in FIG. 4. At the highest level, each advertiser has one or more accounts, while each account in turn contains several ad campaigns.

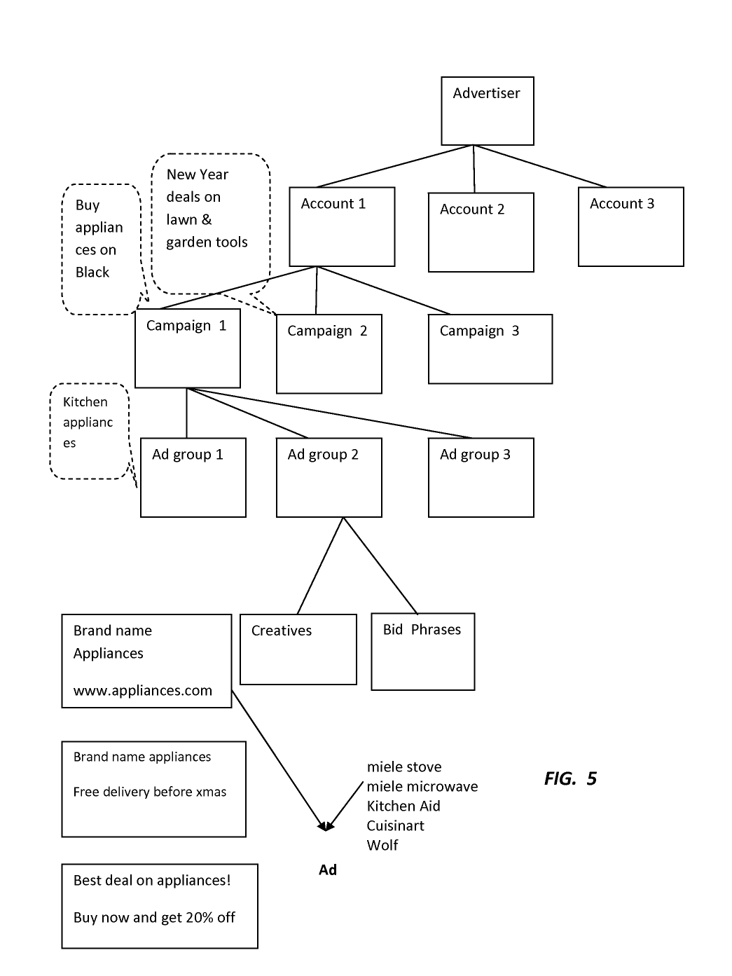

FIG. 5 illustrates the role of ad campaigns with two examples under “Account 1,” where each ad campaign targets a different sale event (or promotional campaign). Campaigns consist of ad groups, which can have multiple creatives and multiple bid phrases. In the example, an ad group promotes the sale of kitchen appliances within the Black Friday appliance campaign.

An ad, as seen by the user, is a particular combination of a creative and a bid phrase. Any creative can be paired with any bid phrase in the same ad group. This type of ad schema has been designed with the advertisers' needs in mind, as it allows the advertisers to easily define a large number of ads for a variety of products and marketing messages. Each bid phrase can be a different product or service offered by the advertiser. Different creatives represent different ways to advertise those products, for example, one creative can offer “buy one, get one free”, while another can offer a “20% discount.” Usually the number of creatives is limited to a few dozens, while each ad group can have hundreds or even thousands different bid phrases.

Advertiser Perspective.

Sponsored search allows advertisers to obtain traffic to their web sites. There are varieties of web sites with different business models participating in sponsored search: transactional sites offering products and services, soliciting user information for sales, petition signing. In general, we assume that the advertisers get some utility (or return) from participating in sponsored search. One proxy for the advertiser utility is the number of conversions. The bid phrase conversion has been used to describe a wide spectrum of action that the advertisers want the user to engage in at their web sites (sales, fill in information request, sign a petition).

Advertisers are charged for each visit brought by a sponsored search click and thus expect a return from the user visit. A simple way to measure the return on the investment (ROI) is to calculate the cost per conversion as a ratio of the sum of the cost of each click (visit to the advertiser's web site) and the number of conversions.

The conversion cost measure of advertiser utility can be used in cases when there is low variance in the click cost and the return per conversion. However, the utility of the conversion and their cost can vary widely. FIG. 4 shows a general view of the advertiser utility funnel. In this view there are five levels of the user interaction with the ad and the advertiser. If we define the ultimate utility of the advertiser as a long term profit, each level provides some value.

For example, even an un-clicked ad impression can provide some value as it raises user awareness about the advertiser (branding) and could induce the user to visit the advertiser's site in the future. Such value is not captured in the conversion events. Another issue with using conversion cost as a proxy for the utility is that the return per conversion can vary. Conversions bring very different revenue (sale of a spare washer machine vs. a replaceable filter) and could bring different profit varying by an order of magnitude (a clearance item vs. a premium brand item). Hence, under the model that the mechanism of the generalized second-price auction is incentive compatible, a rational advertiser should bid.

Bid generation.

In the following we denote by q a query (or keyword) that a search engine user might have issued to obtain search results. Moreover, let b be the bid that an advertiser is willing to issue for the display of an advertisement a. Depending on the advertiser, the mapping a−q may or may not be unique: some advertisers choose to display an ad (a=petshop) for a range of queries (q=dog collar or q=red dog collar) whereas others might pair specific ads with each query. To have the ad a displayed for query q, an advertiser makes a bid b which specifies how much he is willing to offer for a click on the ad. The listing of the ads is implemented by a generalized second price auction where the order is determined by product of the bid and the click probability, that is, by b·p(click|display, q, a). The list of advertisers is truncated beyond a maximum list length and if the bid is below the reserve price determined for a given keyword.

To increase the amount of clicks an advertiser receives he may opt into the advanced match system. That is, the ad a may also be considered for display in response to queries q′ provided that they are related to q and provided that q′ is of sufficient commercial value for a. This raises the issue of determining a suitable bid b′ for q′ automatically on behalf of the advertiser. We treat this as a regression problem. That is, we aim to find a mapping from the pair (a, q) to a matching bid b given a suitably prepared set of observations. When needed, we express this by the functional dependency: b: (a, q)−b(a, q).

In the following we discuss two sources of information: the bid landscape and economic considerations.

Bid Landscape

Advertisers provide us with useful information by storing triples (a, q, b), where a is the ad, q is the query, and b is the bid, for their current and past campaigns. In the following we assume that these triples are drawn from some distribution p(a,q,b). Samples from this distribution are significantly biased towards common queries q which happen to be commercially relevant and suitable for the ad a. That is, it is unlikely that a pet shop would insert a bid of the form (a, q=‘bottle opener’, b=$0) into its database. Instead, we are likely to see bids for (a, q) pairs which considerably exceed those of random combinations of ads and keywords.

In the most extreme case an advertiser might choose to bid the same amount on a number of queries q and $0 on all other queries. This occurs in a surprisingly high number of cases. Fortunately, there exists a sufficiently large number of advertisers who provide us with a more varied range of bids and it is the latter that prove useful in estimating a functional dependency between pairs (a, q) and the associated bid b.

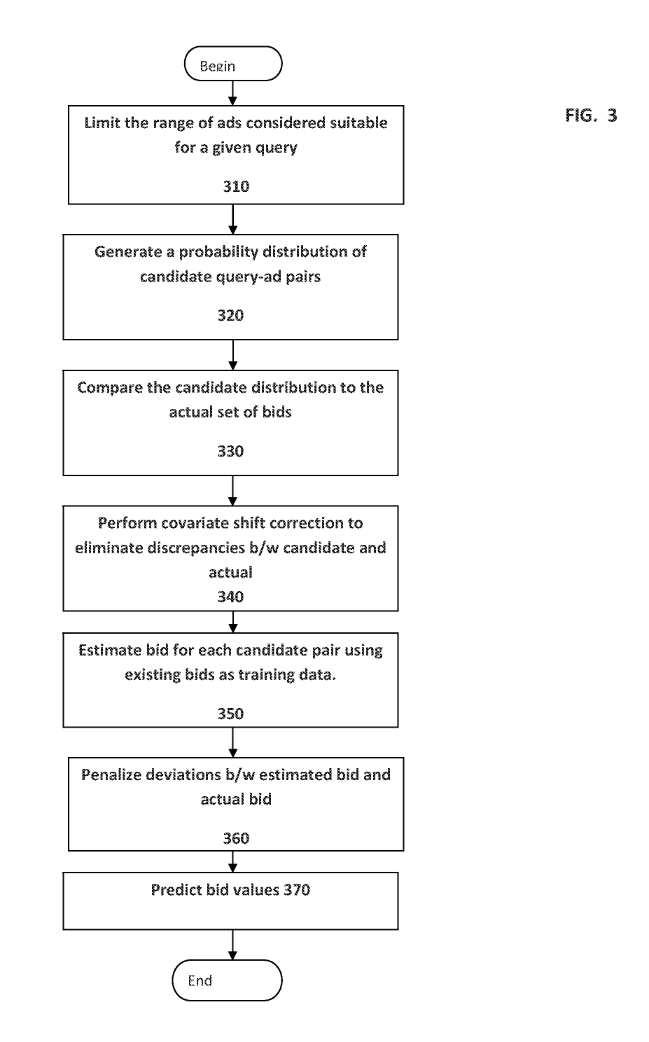

We deal with this bias by decomposing the bid generation problem into two subproblems. Referring now to FIG. 3 a flow chart illustrates the method of generating bids for advanced match in sponsored search. The inputs to the method are: conversion data and exact match bids. Firstly, in stage one, in step 310 we limit the range of ads a which are considered suitable for a given query q using basic information retrieval technology (similar to an initial ranking process in web page ranking). In step 320 we generate a probability distribution of candidate pairs (q, a). This ensures that the candidate distribution of possible (q, a) pairs is not too dissimilar from the actual set of bids. We then compare the candidate distribution of (q, a) pairs to the actual set of bids in step 330. In step 340 we deal with the remaining discrepancy by covariate shift correction. Covariate shift correction is defined in “Covariate Shift by Kernel Mean Matching,” by Arthur Gretton, Alex Smola, Jiayuan Huang, Marcel Schmittfull, Karsten Borgwardt, and Bernhard Schölkopf.

In stage 2, continuing with step 350 we estimate the random variable b|a, q using the advertisers' existing bids as training data. Both stages are necessary: the first stage limits the set of potential ads whereas the second one fine-tunes the bids such that they most closely match what an advertiser would have offered had he chosen to display an ad for a given query.

In step 360, assuming we have the true bid b for a given (q, a) pair we need to determine by how much a deviation between the true bid b and the estimate b should be penalized. Overall, we posit that the class of functions

L(b,b):=*(V(b)−V(b))

is suitable to measure the discrepancy between the “true” bid and its estimate. Here i/>: R−R is a strictly increasing function and 1: R−R is a convex nonnegative function which satisfies without loss of generality that 1 (0)=0.

Picking the identity i/>(x)=x is not necessarily in the advertiser's best interest: while this strives to minimize the average prediction error, it means that an error of $0.05 for a bid of $10.00 has equal value as that error for a bid of $0.10. In other words, advertisers for cheap keywords are at a significant disadvantage in terms of estimation accuracy. This is undesirable since advertisers are mainly concerned about estimation performance relative to their expense rather than in absolute terms. Choosing the transformation i/>(x)=log x achieves this goal.

Secondly, we choose squared loss I(x)=¹ x² to penalize deviations on the log-scale. Log-normality of errors is a common assumption in financial mathematics (e.g., the Black-Scholes model of option pricing uses the same assumption). Note that a large number of alternatives are possible, for instance Huber's robust loss which limits the influence of outliers. In a nutshell, Huber's robust loss is identical to a least mean squares loss within some region |b−b|<a and it becomes an absolute deviation loss beyond that. This has the effect of limiting the derivatives of the loss to have bounded values within the interval [−a, a]. In summary, we use the loss

1²=2\ log b(a, ^{s}, q)−log b(a, s, q), to compute /3 :=log b directly, yielding bids via b=e. Finally in step 370 a bid value is generated.

Risk.

Doing well on a single bid per se is not very meaningful. Instead, we want to ensure a measure of performance which quantifies progress on the entire range of combinations (a, s, q). Hence we may define the expected risk via

R:=L(b(a,s,q),b(a,s,q))w(a,s,q)

Here w(a, s, q) is a weighting function which ensures that we emphasize goodness of fit in relevant regions. Moreover, we will need to fashion a corresponding empirical risk term

R=L(b(a,s,q),b(a,s,q))w(a,s,q)

which tries to approximate R as well as possible. Here Z contains all available data and w(a, s, q) denotes a weighting term associated with the available data.

Given that we have two different sources of information, namely conversion data for calibration and exact matching bids for bid scale we can decompose R via

R−ARe+(1−A)R_{advanced match} for A £(0,1).

Here R_{exact match} denotes the performance on the subset of data obtained by leave-one-out computation on the set of exactly matching observations and R_{advanced match} denotes the calibration information obtained from conversion data.

It is difficult to adjust A in an entirely principled fashion due to the different types of bias inherent in the data: the bid data contains a mix between exact match and advanced match estimates, it is drawn primarily from the head of the distribution, and quite often, the advertisers' ability to estimate prices that are in their own best interest are somewhat limited due to suboptimal data analysis. On the other hand, conversion data suffers from the fact that only a biased subset of advertisers opts into this process and that moreover, the definition of a conversion is highly variable (e.g. in some anomalous cases advertisers find 100% conversions) among advertisers. We address these issues by an extensive comparison analysis between estimates obtained from bid and from advanced-match data.

Generalized Linear Model

The basic estimator we use is quite simple: we use a generalized linear model to capture the dependency between queries, bid phrases, and advertisers. Some care is required, however, in setting up the regression problem: in the context of advanced match we have a query q′ and an associated ad s with bid phrase q=q′ for which we would like to assign a bid b. Here the ad s is obtained by means of an information retrieval process which we treat as a black box for the purpose of this paper. This means that we have a mapping of the quintuple (a, s, q, b, q′)−b′ where we extract features </>(a, s, q, b, q′) in order to obtain for a suitably chosen parameter vector w. Note that this function two additional parameters over the standard bid function b(a, s, q): the bid b for the matching ad and its associated keyword q. Both pieces of information are vital: for instance, if q and q′ are very dissimilar it is unlikely that the bid for q′ should be very high. Furthermore, b provides useful calibration information regarding the value of s.

For conversion data the quintuple (a, s, q, b, q′) is automatically well defined. On exact match data, however, some care is needed: by definition we only have quadruples (b, a, s, q) rather than tuples (b, a, s, q, b′,q′). We address this problem by generating synthetic data: for a given (b, a, s′,q′), using standard information retrieval techniques, we find an ad (b, a, s, q) matching the query q′ for which q=q′. This data is then used to compose the tuple needed for pretend-estimating an advanced match query.

The motivation for this approach is that the estimator should be capable of recovering the advertisers' true bids for exact match data. After all, this is the only data where we have proper information about what the advertiser actually intended to bid. In summary, we have the following minimization problem:

w=argmin w(a,s,q′)2[log b′−(</?>(a,s,q,b,q′),w)(b,a,s,q,bf,q′)

Here the sum over tuples (b, a, s, q, b, q) is carried out over available training data (either exact match only or exact and advanced match combined).

Finding a near-optimal solution of the above optimization problem is straightforward—one simply employs stochastic gradient descent. That is, we use the following optimization algorithm:

1) Initialize w=0 and n=n₀ repeat;

2) Get new (b, a, s, q, b′, q′);

3) Increment counter n−n+1;

4) Set learning rate r\=c/*Jn;

5) Compute error 5=(<j>(a, s, q, b, q′),w)−log b;

6) Update w−w−r\·5·4>(a, s, q, b, q′) until no more data.

It can be shown that the above algorithm converges at rate O(T⁻²) to the risk minimizer. In practice, a very small number of passes through the data (i.e. in the order of 10 iterations) suffices.

Note that the estimator we describe is effectively an empirical risk minimization procedure. That is, we only strive to minimize the mis-prediction errors on a given set of data rather than taking an additional penalty such as a small value of the parameter vector into account. This is achieved by performing early stopping which ensures that the parameter remains bounded. In practice this is as effective as regularized risk minimization, with the added benefit of a significantly more efficient implementation in the context of stochastic gradient descent. VowpalWabbit can be used as the underlying online solver.

Connection to Exponential Families: It is tempting to estimate the conversion probability directly, in particular when dealing with advanced match data exclusively. That is, we could attempt to build a logistic regression model with

p(conversion|click,a,s,q)1+exp(−f(a,s,q))′

For small conversion probabilities we have that in first order approximation log p˜f (a, s, q) which leads to

b˜bexp(f(a,s,q′)+log b−log pconversion|click,a,s,q)).

This is a special case of the exponential linear model we employ for regression. Since both the logistic model and the Gaussian LAMS model are consistent we see that in first order approximation both models are equivalent.

Budget Calibration

Our methodology predicts bid values based on existing bids of the same advertiser as well as bidding behavior of other advertisers. When taking into account others' bids, we should obviously only consider bids of live ads that are being displayed and disregard those of dormant or discontinued campaigns. But should a bid of an ad showing once a month be trusted to the same extent as the one showing thousands of times a day? At the very least, frequently displayed ads are likely to be much better tuned, and hence their bids are likely to be more realistic in the given market. We capture this intuition by weighting bids by the amount of money spent by the advertiser.

A key issue is the degree to which we weigh instances (a, s, q, b, q). Clearly, it is desirable to scale keywords by their commercial relevance. After all, keyword and bid combinations that attract no commercial interest should not form the basis of our estimate. More specifically, the financial impact of mispredictions correlates directly with the amount of money spent on the relevant keywords. Consequently we use the following weighting function:

w(a,s,q,q)=Spent on (s,q) by advertiser a

Scale Neutrality: An immediate consequence of this weighting is that estimates which have the same relative error in terms of bid estimation will lead to the same amount of overall error contribution regardless of the level of the actual bid. More concretely, an advertiser spending $100 on bids of a price of $1 each and an advertiser spending the same amount on bids of a price of $10 each, both of which attract a relative error of, say, 5%, will generate the same error contribution. Had we chosen to pick squared absolute deviations rather than deviations in the logarithm, both settings would have incurred a much different loss−102·(1−1.05)2=0.25 vs. 0.0025 for the advertiser using 1$ auctions.

Robustness: A desirable side-effect of weighting by budget is the bid estimator becomes highly robust regarding manipulation by advertisers: assume that an advertiser would like to manipulate the process of estimating bids for advanced match. If he were to increase his bid in the hope to increase the bid estimate for advanced match of a competitor, his data would only be weighted by his actual amount spend on the keyword. Consequently significant manipulation would require resources proportional to the degree of manipulation. Likewise, if the advertisers were to try and lower his bid, the advertiser will fail to win auctions and as a result his spend on the keyword will decrease, thus decreasing his statistical weight. This prevents a strategy in which an advertiser alternating bids low on a keyword waits until at the next iteration of the estimator the advanced match bid for other participating advertisers has been lowered in order to take advantage of the now lowered price.

Backoff Smoothing

One of the problems arising in using conversion data for bid generation is that such information can be sparse. That is, while we might have a sizable number of conversion events per advertiser, it is quite common to have many keywords for which only a single conversion has been recorded. Consequently the estimates of the associated conversion probability can be very unreliable.

p(a,c)=

p(a,c,s)=

We use a simple technique from natural language processing to address this problem: backoff smoothing of counts. The basic idea is that aggregate conversion probabilities at a given level will be a good prior for conversion probabilities at the next lowest level (e.g. a good prior for conversion probabilities for bid phrases are the conversion probabilities for the associated ad group). More specifically, we use hierarchical Laplace smoothing as follows: denote by p, p(a), p(a, c), p(a, c, s), p(a, c, s, q) the conversion probabilities of the hierarchy, i.e. (general, per advertiser, per advertiser and campaign, per advertiser, campaign and adgroup, per advertiser, campaign, adgroup and bid phrase). Likewise, denote by nconv, . . . , nconv(a, c,s,q) the number of conversions and by nciick, . . . , nciick(a, c,s,q) the number of clicks. Then we define the following estimates recursively.

In practice we choose n₀=10. The rationale is that we would like n₀·P_{conv}=O(1) in order to obtain a smoothing effect as in Laplace smoothing. Note that as the sample size increases, this estimator will converge to the true probability estimate, that is, the estimator is consistent. This follows from the fact that conjugate priors yield consistent estimators. The above procedure implements a Laplace smoother where we used the probability estimate at the higher hierarchy as a conjugate prior.

Missing Variables

Missing Variables is a problem that occurs consistently in sponsored search: for instance, some queries might be sufficiently rare that no features regarding their relationship are available, systems might fail to record and process data, or certain features may not be well-defined (e.g. bid variance is undefined for advertisers with only one bid).

In the following we denote by xₒ the observed random variables and by xᵤ the unobserved (hence missing) part of an observation. It is tempting to approach the regression problem of computing (w, x) by estimating the unobserved random variables xu|xo first and to simply plug the conditional estimate into the linear function (w, x). This approach is not desirable since it ignores a number of aspects:

1. There may be significant estimation error associated with trying to find the missing variables conditioned on the fact that they are missing.

2. The variables may not be missing completely at random. In other words, the fact that we have partial information might be indicative of a particular type of data (e.g. the case of missing variance for advertisers with only one bid).

3. At runtime the estimation process is slower since we first need to estimate the value of the missing variables and only then apply the linear function (w, x).

These problems can be all addressed by defining the following feature representation: instead of x we use

|(xᵢ,0) if xᵢ is observed Xᵢ−<,(11)(0,1) if xᵢ is missing

The result of this transformation is that we now estimate xi·wi and the contribution when xi is not observed, that is, wi>miss, directly. This means that we never need to compute the value of the missing variables at all and moreover, that we simply perform the linear-optimal correction provided that xi is missing. The only drawback of this approach is that we are unable to take the actual value of the remaining observed features into account.

Query Features

The idea concerning query features is that similar queries should lead to similar bids. For instance, bids for the query ‘red roses’ should tell us more about suitable bids for ‘white roses’ rather than for ‘car insurance’. We use the following query features:

1. A TFIDF (term frequency-inverse document frequency) weighted vector representing the query as a bag of words and phrases—note that this leads to a potentially unlimited number of different features; We denote this feature by q.

2. The number of unigrams and the number of phrases identified in q. The rationale is that the length of a query is indicative of its prevalence.

3. Following [2], we expand the query with Web search results, and take the most salient Nw=50 unigrams and Nph=50 phrases from these results as additional features of the query. This ensures that queries with similar search results are considered similar.

4. The query frequency in Web search logs over the previous month.

5. The minimum and maximum document frequency (DF) of the query words and phrases in the Web corpus

6. The number of advertiser accounts bidding on the query as a bid phrase. This tells us how competitive a given keyword is (this is indicative of the discount relative to the value for an advertiser).

7. The average, minimum, and maximum bid on the query (if any) across all advertiser accounts.

### Ad Features

By the same token we can compute features specific to the ad to be displayed. Whenever dealing with text we use a TFIDF representation of ht as a bag of words vector. Overall, we concatenate the following features:

1. Simple statistics of the ad group as well as its enclosing campaign and account: the number of bid phrases, the number of creatives, the average, minimum and maximum bid, the average, minimum and maximum frequency of bid phrases as queries in Web search.

2. The centroid of all the bid phrases in the ad group, denoted as Centroidbp.

3. The centroid of the expansions of bid phrases with Web search results, denoted by Centroidbp_exp, similar to its expansion for queries.

4. The centroid of the text of all creatives in the ad group, Centroidcreat.

5. The topical cohesiveness of the ad group, as well as its campaign and account, computed as an average distance of bid phrases and creatives from the corresponding centroids (see items 2-4 above).

Ad-Query Features

Since the obvious combination of per query and per ad features by taking outer products may become computationally prohibitive we compute explicit features as follows: we compute the Cosine similarity measure between q and the centroids Centroidbp, Centroidbp_exp, and Centroidcreat.

We employ the leave one out approach for training and also for evaluating our methodology. That is, we use this approach also for predicting existing bids of actual ads in our corpus. For a fair experiment we obviously need to exclude the bid phrase and its bid value from any feature computation used for predicting the bid value.

### Data Description

We evaluated our methodology on a real-life-sized subset of advertising data. Our experiments are based on a fraction of Yahoo's ad database as of [[MONTH]] 2009. This snapshot included [[XXX]] advertiser accounts, [[YYY]] campaigns, and [[ZZZ]] ad groups.

We adopted the “leave one out” approach, which allowed us to test the ability of our system to predict actual bids that the advertisers explicitly specified for existing ads. This way, advertiser-specified bids served as the “gold standard”—the rationale was that after all advertisers should know best what they would like to bid for an keyword.

There are two important classes of data that we excluded from the dataset for the following reasons. First, we excluded all ad campaigns that had constant or near-constant bids, since such campaigns provide no information to discriminate between the possible bid values, and our method will be effectively forced to predict that constant value. Our definition of near-constant bids was a bid variance of less than 0.05 (this is significantly less than the error of the bid predictor that we computed, hence including such advertisers would only improve the error rate).

Second, we eliminate ad groups that have only one bid as taking this bid out leaves the ad group empty and useless for leave-one-out testing (however, we do use such ad groups for computing various global statistics such as the number of advertisers bidding on a given phrase). To clarify, we use ad groups with two or more bid phrases if their bids are not near-identical.

Having eliminated the two classes of data items as explained above, we ended up with an ad corpus with [[XXX]] advertiser accounts, [[YYY]] campaigns, and [[ZZZ]] ad groups. We then created three different test sets to simulate the following real-life scenarios:

1. When an advertiser establishes a new account, the system is able to generate bid values for the account immediately. To evaluate the ability of our system to support this scenario, we formed the first test set (referred as ACCT below) by randomly selecting 10% of advertiser accounts. In each account, we used the leave one out approach to predict each bid given all the other ones, but none of these accounts' data was included in the training set. Consequently, this is the most difficult dataset.

2. The second test set was similarly designed to evaluate our system's ability to predict bids for newly defined ad campaigns. We defined this set (CAMP) by randomly selecting 10% of all the campaigns and putting all of their bids into the test set (to wit, other campaigns belonging to the same account could be included in the training set).

3. Finally, we emulate the addition of a new bid phrase to an existing ad group. To this end, we defined the third test set (PHRASE) by randomly selecting 10% of individual bid phrases

To summarize, we apply the {90%,/10%} split at different levels of the ad hierarchy to test the prediction abilities of our system at different resolutions.

Sample Weighting

To evaluate the soundness of the budget calibration we use the funds spent in the previous week to weigh the accuracy of bids. Moreover, to address questions regarding the validity of the weighting approach we compare the performance of estimates obtained by uniform weighting (ignoring money spent per bid phrase) and by our proposed weighting scheme. This leads to the following experiments:

1. Both training and test examples are weighted uniformly (UNIFORM).

2. Only test examples are weighted (WEIGHTED-TEST).

3. Both training and test examples are weighted according to actual spend (WEIGHTED-BOTH).

As an evaluation metric we use the least mean squares error defined supra. That is we penalize by the squared deviation between the logarithm of the bid and the logarithm of the estimate.

Baseline

Our methodology uses a multitude of features to predict the bid value for a given bid phrase. In order to test whether this complexity is warranted, we also used a simple baseline that only uses bid values for other phrases in the ad group in order to predict a bid value for a new phrase.

To justify our choice of the baseline, let us first revisit the ad retrieval method, which selects candidate ads to be shown on the page. Given a Web search query q′, it retrieves a number of relevant ads, where each ads is composed of a creative and a bid phrase q (we assume that q=q′, that is we assume that q was not explicitly bid on by the advertiser, and hence this bid needs to be predicted at runtime).

While the implementation details of the retrieval module are outside of the scope of this paper, the retrieval module identifies relevant creatives and pairs them with the most relevant bid phrase. Note that each creative s may be paired with multiple bid phrases q. We average the bid values b of the ad group containing s and q, and we use this average value as our baseline. Since there may be significant variance within bids of an ad group we believe that averaging the values in an ad group is more appropriate than taking any one of them individually.

Bid Generation for Exact Match Advertisers

As explained above, there are two primary scenarios of ad matching in sponsored search, namely, exact match and advanced match. Usually, advertisers opt into advanced match in order to have their ads displayed for more queries. However, a small fraction of advertisers choose to only use exact match. Arguably, these advertisers produce their bids on more reliable data, as it is much easier for them to compute the true value of each keyword. Consequently, we believe it is interesting to conduct an experiment on these advertisers only, as their bid values are the most precise.

We performed this experiment by restricting the PHRASE test set to those ad groups that only enroll into exact match (i.e., have advanced match disabled); we used WEIGHTED-BOTH weighting to make the results comparable to the previous ones.

Using Conversion Data

For a fraction of advertisers, we have access to conversion data, which reflects the fraction of users who actually purchase the product or service being advertised after clicking on the ad. Intuitively, this information is highly valuable for bid generation, since knowing how different bid phrases “convert” can lead to a better estimation of their true value to the advertiser.

Feature Selection

Our method uses multiple features of different types. We performed a series of ablation studies to assess the informativeness of different features. Owing to the multitude of features used by our model, each time we eliminated an entire group of similar features rather than individual ones.

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method of generating bid values for sponsored search in search engines on behalf of an advertiser selling an item, said method comprising:
receiving a bid phrase for an advertisement for the item, wherein said bid phrase specifies a search query for which the advertisement should be displayed;
receiving first information at a first input/output interface, said first information relating to a bidding behavior of the advertiser;
receiving second information at a second input/output interface, said second information relating to a history of bids by other advertisers for the bid phrase; and
generating a bid value for the bid phrase submitted for the advertisement for the search query, based on the information received.

2. The method of claim 1 wherein receiving the first information comprises receiving a triple of advertisement, query, and bid for the advertiser's current and past campaigns.

3. The method of claim 1 wherein receiving the first and second information comprises receiving conversion data.

4. The method of claim 1 further comprising using a generalized linear model to capture a dependency between queries, bid phrases, and training the model to guess the bid value for the bid phrase.

5. The method of claim 1 further comprising deriving features characterizing a query, an ad, and their interaction, and experimentally valuating a utility for these features.

6. The method of claim 1 wherein receiving the bid phrase comprises receiving a phrase related to a search query for which there is no explicit bid from an advertiser.

7. The method of claim 1 wherein generating the bid value comprises steps of:
limiting a range of advertisements deemed suitable for the search query into a sampling of advertisements;
training bids on the sampling of advertisements;
determining an acceptable threshold of deviation between an actual bid and an estimate bid; and
penalizing any deviations beyond the threshold.

8. A system for generating bids for sponsored search in search engines on behalf of an advertiser selling an item, said system comprising:
an information processing device;
an information storage device comprising data and instructions that when executed by the information processing device perform a method comprising:
receiving a bid phrase for an advertisement for the item, wherein said bid phrase specifies a search query for which the advertisement should be displayed;
a first input/output interface receiving first information, said first information relating to a bidding behavior of the advertiser;
a second input/output interface receiving second information, said second information relating to a history of bids by other advertisers for the bid phrase; and
generating a bid value for the bid phrase submitted for the advertisement for the search query, based on the information received.

9. The system of claim 8 wherein the first information comprises a triple of advertisement, query, and bid for the advertiser's current and past campaigns.

10. The system of claim 8 wherein the first and second information comprise conversion data.

11. The system of claim 8 wherein the first and second information comprise features characterizing a query, an ad, and their interaction.

12. The system of claim 8 wherein the bid phrase comprises a phrase related to a search query for which there is no explicit bid from an advertiser.

13. The system of claim 8 wherein the information storage device further comprises instructions for generating the bid value by performing:
limiting a range of advertisements deemed suitable for the search query into a sampling of advertisements;
training bids on the sampling of advertisements;
determining an acceptable threshold of deviation between an actual bid and an estimate bid; and
penalizing any deviations beyond the threshold.

14. The system of claim 8 further comprising:
a data store storing the first and second information.

15. A non-transitory storage device comprising an information storage device comprising data and instructions that when executed by the information processing device perform a method comprising:
receiving a bid phrase for an advertisement for the item, wherein said bid phrase specifies a search query for which the advertisement should be displayed;
receiving first information at a first input/output interface, said first information relating to a bidding behavior of the advertiser;
receiving second information at a second input/output interface, said second information relating to a history of bids by other advertisers for the bid phrase; and
generating a bid value for the bid phrase submitted for the advertisement for the search query, based on the information received.

16. The storage device of claim 15 wherein the first and second input/output interfaces are combined into a single input/output interface.

17. The storage device of claim 15 wherein the first information comprises conversion data.

18. The storage device of claim 12 further comprising a generalized linear model capturing a dependency between queries, bid phrases, for training said model to guess the bid for the bid phrase.

19. The storage device of claim 15 further comprising a bid suggestor.

20. The storage device of claim 15 wherein the bid phrase comprises a phrase related to a search query for which there is no explicit bid from an advertiser.
